(19) United States
(12) Patent Application Publication
(10) Pub. No.: US 2023/0256512 A1
(43) Pub. Date: Aug. 17, 2023

(54) SUBSTRATE PLATE FOR AN INTERCHANGEABLE CONTAINER, INTERCHANGEABLE CONTAINER AND METHOD AND APPARATUS FOR UNPACKING A THREE-DIMENSIONAL OBJECT PRODUCED BY SELECTIVE SOLIDIFICATION OF A PULVERULENT BUILD MATERIAL ON A SUBSTRATE PLATE OR IN THE INTERCHANGEABLE CONTAINER

(71) Applicant: TRUMPF Laser- und Systemtechnik GmbH, Ditzingen (DE)

(72) Inventors: Daniel Giek, Stuttgart (DE); Wolfgang Laib, Besigheim (DE)

(21) Appl. No.: 18/303,590

(22) Filed: Apr. 20, 2023

Related U.S. Application Data
(63) Continuation of application No. PCT/EP2021/078139, filed on Oct. 12, 2021.

(30) Foreign Application Priority Data
Oct. 30, 2020 (DE) 10 2020 128 658.9

(51) Int. Cl. B22F 10/28; B22F 10/68; B22F 12/00; B22F 12/30

(52) U.S. Cl. CPC B22F 10/28; B22F 10/68; B22F 12/30; B22F 12/38; B33Y 40/20

(57) ABSTRACT

A substrate plate for an interchangeable container that can be inserted into an apparatus for layer-by-layer application and selective solidification of a pulverulent build material for producing a three-dimensional object is provided. The substrate plate includes a surface on which the three-dimensional object is built, and a connection interface situated opposite to the surface. A transmission element is capable of being connected to the connection interface. At least one actuator is capable of being connected in a force-fitting and/or form-fitting manner to the substrate plate or to the transmission element fastened to the substrate plate. The at least one actuator is capable of being excited to oscillate by a generator.

### CROSS REFERENCE TO RELATED APPLICATIONS

This application is a continuation of International Application No. PCT/EP2021/078139 (WO 2022/089933 A1), filed on Oct. 12, 2021, and claims benefit to German Patent Application No. DE 10 2020 128 658.9, filed on Oct. 30, 2020. The aforementioned applications are hereby incorporated by reference herein.

### FIELD

Embodiments of the present invention relate to a substrate plate and to an interchangeable container for an apparatus for the layer-by-layer application and selective solidification of a pulverulent build material for producing a three-dimensional object. Embodiments of the present invention also relate to a method and an apparatus for unpacking a substrate plate and a three-dimensional object produced by layer-by-layer application and by selective solidification of a pulverulent build material in an interchangeable container.

### BACKGROUND

DE 10 2017 108 080 A1 discloses a method and an apparatus for unpacking an object produced by layer-by-layer application. An interchangeable container is positioned in an upright position in a turning apparatus. The interchangeable container is then rotated by the turning apparatus to an emptying position for discharging the non-solidified build material. In this case, the three-dimensional object is unpacked by the build material being discharged from the interchangeable container by the weight force. The turning apparatus is then returned to the starting position again such that the interchangeable container is in an upright position, in order to remove said interchangeable container from the unpacking apparatus.

Furthermore, DE 10 2013 223 407 A1 discloses an apparatus for unpacking a three-dimensional object produced from a pulverulent build material by layer-by-layer application and selective solidification in an interchangeable container. The interchangeable container is inserted into a rotating apparatus. The rotating apparatus is then rotated to an emptying position, such that the opening in the interchangeable container points downwards. In order to remove the powder from the object, a vibration is applied to the interchangeable container from the outside.

### SUMMARY

Embodiments of the present invention provide a substrate plate for an interchangeable container that can be inserted into an apparatus for layer-by-layer application and selective solidification of a pulverulent build material for producing a three-dimensional object. The substrate plate includes a surface on which the three-dimensional object is built, and a connection interface situated opposite to the surface. A transmission element is capable of being connected to the connection interface. At least one actuator is capable of being connected in a force-fitting and/or form-fitting manner to the substrate plate or to the transmission element fastened to the substrate plate. The at least one actuator is capable of being excited to oscillate by a generator.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic sectional view of an interchangeable container with an actuator connected to a substrate plate according to some embodiments;

FIG. 2 shows a schematic sectional view of an interchangeable container with an actuator connected directly to a transmission element according to some embodiments;

FIG. 3 shows a schematic side view of an apparatus for unpacking an interchangeable container in a first working position according to some embodiments, and

FIG. 4 shows a schematic side view of the apparatus according to FIG. 3 in a further working position according to some embodiments.

### DETAILED DESCRIPTION

Embodiments of the present invention provide a substrate plate, in the case of which an actuator which can be excited to oscillate by a generator is connected in a force-fitting and/or form-fitting manner to a substrate plate or to a transmission element connected to the substrate plate. This force-fitting and/or form-fitting connection between the actuator and the substrate plate or the transmission element makes it possible for the oscillations excited by the actuator to be coupled immediately and directly into the substrate plate or into the transmission element. This makes it possible to transmit the oscillations generated by the actuator to the substrate plate or to the transmission element in an undamped manner, as a result of which still adhering build material on a rough surface of the three-dimensional object or in intermediate spaces between portions of the three-dimensional object is depowdered in an improved manner. As a result, a blowing-off operation for the three-dimensional object using nozzles or the introduction of a fluidized bed is not necessary. In addition, the depowdering makes it possible to reduce contamination of the environment with non-solidified build material during the further handling of the three-dimensional object.

Provision is preferably made for the actuator to be connected to the substrate plate or to the transmission element in a mechanically fixed manner. Here, this mechanical connection is configured in such a way that the oscillations can be introduced directly into the substrate plate or into the transmission element. Preferably, play-free fastening of a sound conductor of the actuator with respect to the substrate plate or to the transmission element is provided.

Furthermore, provision is preferably made for the actuator, in particular a sound conductor of the actuator, to be connected to the substrate plate or to the transmission element by screwing, clamping or bracing. By way of example, a threaded bore, into which the sound conductor of the actuator, which is preferably in the form of a pin or plunger, can be screwed, may be provided in the substrate plate or in the transmission element. Bracing by means of a clamping claw or clamping by means of wedge surfaces may also be possible.

Furthermore, provision is preferably made for the generator and the actuator to be connected to one another by means of a high-frequency cable. As a result, the high-frequency oscillations, in particular ultrasonic oscillations, generated by the generator can be transmitted to the actuator which couples these high-frequency oscillations into a sound conductor of the actuator, which is connected to the substrate plate or to the transmission element in a mechanical manner.

Furthermore, provision is preferably made for the actuator to be able to be excited to a high frequency in a range from 30 to 40 kHz. This high-frequency excitation enables particularly good depowdering of the three-dimensional object.

Embodiments of the present invention also provide an interchangeable container for an apparatus for the layer-by-layer application and selective solidification of a pulverulent build material for producing a three-dimensional object, said container comprising a building cylinder in which a substrate plate, on which the three-dimensional object is built, can be moved up and down or in which the substrate plate, which is connected to a transmission element which points towards the outer side of the building cylinder, can be moved up and down together in the building cylinder, wherein at least one actuator which can be excited to oscillate by a generator can be connected, in particular is connected, in a force-fitting and/or form-fitting manner to the substrate plate or to the transmission element fastened to the substrate plate.

Embodiments of the present invention also provide a method for unpacking a three-dimensional object produced by layer-by-layer application and selective solidification of a pulverulent build material on a substrate plate from the non-solidified build material surrounding the object, in which a substrate plate according to one of the preceding embodiments is inserted into a turning device and is rotated from an upright working position to an emptying position for unpacking the three-dimensional object by the weight force of the build material, and in which, after the three-dimensional object has been unpacked, the at least one actuator is excited to oscillate by the generator in order to depowder the three-dimensional object, and, after the three-dimensional object has been depowdered, the substrate plate is returned to an upright working position for removal from the interchangeable container. This makes it possible, successively in one operation, for the non-solidified build material to first be unpacked by the weight force and for still adhering build material on the three-dimensional object to then be depowdered. On account of the rough surface and/or undercuts and/or gaps of the three-dimensional object, which is produced by layer-by-layer solidification of the pulverulent build material, an increased level of cleanliness can be achieved. This has the advantage that the contamination by the still adhering build material on the three-dimensional object can be reduced. In addition, any subsequent work, such as a heat treatment, can be improved, since additional manual dedusting beforehand can be omitted.

Furthermore, provision is preferably made for the substrate plate or the transmission element which is preferably releasably connected to the substrate plate to be excited to oscillate at 30 to 40 kHz. This high-frequency oscillation leads to particularly good depowdering of the three-dimensional component. On account of the direct coupling of the oscillations into the substrate plate or into the transmission element connected to the substrate plate, the excited oscillation is registered directly, and transmission of the oscillations to the building cylinder of the interchangeable container is damped or eliminated by the at least one seal which is arranged on the substrate plate or on the transmission element.

According to a further advantageous configuration of the method, it is provided that, after the substrate plate has been introduced into the turning device and the substrate plate has been transferred to the emptying position, the at least one actuator is connected in a force-fitting and/or form-fitting manner to the substrate plate or to the transmission element connected to the substrate plate. As a result, substrate plates which are already in use can be used for additional depowdering of the three-dimensional object.

Embodiments of the present invention also provide a method for unpacking a three-dimensional object produced by layer-by-layer application and selective solidification of a pulverulent build material in an interchangeable container from the non-solidified build material surrounding the object, in which a turning apparatus is loaded with the interchangeable container, in which the turning apparatus is rotated from an upright working position to an emptying position for unpacking the three-dimensional object by weight force of the build material, wherein a substrate plate which can be moved up and down in a building cylinder of the interchangeable container or a transmission element connected to the substrate plate, which can both be moved up and down in the building cylinder, is connected to at least one actuator in a force-fitting and/or form-fitting manner, wherein the at least one actuator is excited to oscillate by the generator in order to depowder the three-dimensional object.

The further method steps described above for depowdering the substrate plate apply analogously to the substrate plate inserted in the interchangeable container or to the substrate plate, and the associated transmission element, inserted in the interchangeable container.

Embodiments of the present invention also provide an apparatus for unpacking a three-dimensional object produced by layer-by-layer application and selective solidification of a pulverulent build material on a substrate plate, said apparatus having a turning apparatus which receives the substrate plate in an upright position and transfers it to an emptying position for discharging the non-solidified build material by the weight force thereof, wherein the substrate plate is received by the turning apparatus, and, before or after the substrate plate has been positioned in the turning apparatus, in particular after the interchangeable container has been transferred to the emptying position of the turning apparatus, the at least one actuator is connected in a force-fitting and/or form-fitting manner to the substrate plate or to a transmission element provided on the substrate plate, and, after the three-dimensional object has been unpacked, that is to say after the non-solidified build material has been discharged by weight force, said at least one actuator can be actuated to oscillate by the generator in order to depowder the three-dimensional object. The force-fitting and/or form-fitting connection of the at least one actuator to the substrate plate or to the transmission element connected to the substrate plate makes it possible for only a small mass to have to be excited in order to depowder the three-dimensional object. The substrate plate acts as transmitter of the directly incoupled oscillations to the three-dimensional object, which is built directly on the substrate plate. This applies analogously to the direct coupling of the oscillations into the transmission element, which is connected to the substrate plate for example in a mechanical manner, in particular by screw connections.

Embodiments of the present invention also provide an apparatus for unpacking a three-dimensional object produced by layer-by-layer application and selective solidification of a pulverulent build material in an interchangeable container from the non-solidified build material surrounding the object, in which an interchangeable container inserted into a turning device can be rotated from an upright working position to an emptying position for unpacking the non-solidified build material by weight force, and in which a substrate plate which can be moved up and down in the building cylinder of the interchangeable container or a transmission element connected to the substrate plate, which can be moved up and down together with the substrate plate in the building cylinder, can be connected to at least one actuator in a force-fitting and/or form-fitting manner, and wherein the at least one actuator can be actuated to oscillate by the generator in order to depowder the three-dimensional object. Due to the form-fitting and force-fitting connection of the at least one actuator to the substrate plate or to the transmission element which is fastened to the substrate plate, the oscillations can be coupled in directly via the actuator, in order to achieve additional removal of the build material adhering to the three-dimensional object.

Embodiments of the present invention will be described and explained in more detail below on the basis of the examples illustrated in the drawings. The features that can be gathered from the description and the drawings can be used individually by themselves or as a plurality in any combination according to embodiments of the invention. In the figures:

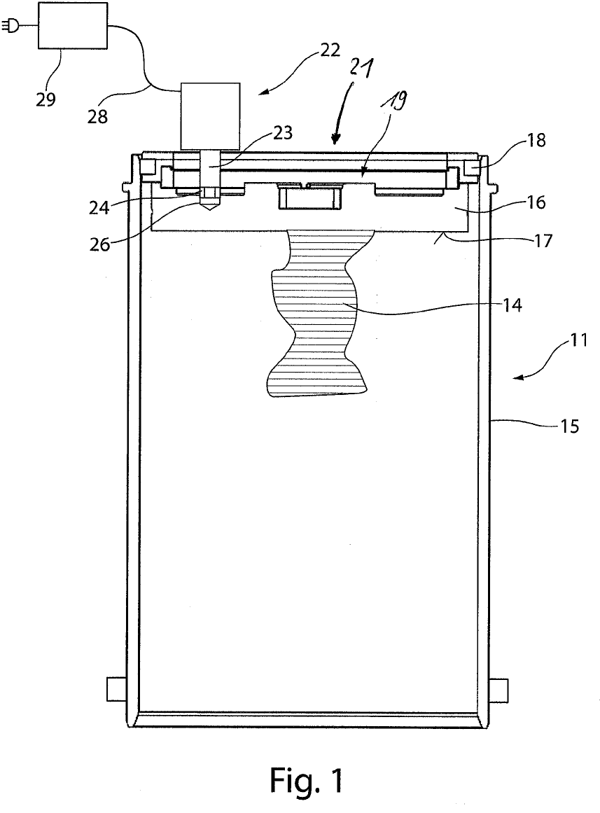

FIG. 1 illustrates a schematic sectional view of an interchangeable container 11. This interchangeable container 11 is inserted into a laser sintering apparatus or laser melting apparatus that is not illustrated in any more detail, in order to produce a three-dimensional object 14 by layer-by-layer application of pulverulent build material in the interchangeable container 11 and by selective solidification of the pulverulent build material, said three-dimensional object being illustrated only in exemplary fashion. Such a laser sintering apparatus comprises an exposure device with a laser source which generates the laser beam, wherein the laser beam is deflected via a deflection apparatus and is supplied by a focussing apparatus, and preferably via an incoupling window into a process chamber, to the build material to be solidified. In this case, the laser beam is focussed on a working plane of the uppermost layer of the build material in the interchangeable container 11. Linear movement of the laser beam makes it possible to solidify the build material layer by layer and produce the three-dimensional object 14. The build material may be a metallic powder or the like. After the three-dimensional object 14 has been produced, the interchangeable container 11, together with the three-dimensional object, is removed from the laser sintering apparatus.

Such an interchangeable container 11 comprises a building cylinder 15 which surrounds a working space. A substrate plate 16 is provided within the building cylinder 15, said substrate plate being able to be moved up and down along the building cylinder 15 by a lifting drive that is not illustrated in any more detail. This lifting drive engages on an underside of the substrate plate 16. The three-dimensional object 14 is built on a surface 17 facing into the building cylinder 15. The substrate plate 16 has at least one seal 18 on an outer periphery. This may be a heat-resistant seal and/or a seal for a process gas.

On an outer side 21 of the substrate plate 16 that is situated opposite to the surface 17 of the substrate plate 16, at least one actuator 22 is connected to the substrate plate 16. This actuator 22 is connected to the substrate plate 16 in a force-fitting and/or form-fitting manner. The actuator 22 comprises a sound conductor 23 which is configured for force-fitting and/or form-fitting attachment to the substrate plate 16. Preferably, a mechanical connection between the actuator 22, in particular the sound conductor 23, and the substrate plate 16 is provided. By way of example, a thread 24 may be provided at the end-side end of the sound conductor 23, said thread engaging into a threaded bore 26 in the substrate plate 16 and being fastened therein. This makes it possible for oscillations generated in the actuator 22 and transmitted to the sound conductor 23 to be able to be coupled directly into the substrate plate 16. This substrate plate 16 is formed from a metallic material and preferably in one piece. The substrate plate 16 acts as an oscillation transmission element, such that the oscillations introduced into the substrate plate 16 are transmitted directly by structure-borne sound to the three-dimensional object 14.

The at least one actuator 22 is connected to a generator 29 by means of a high-frequency cable 28. This generator 29 is an ultrasonic generator which generates ultrasonic oscillations. In particular, ultrasonic oscillations in a range from 30 to 40 kHz are generated by the generator 29. These ultrasonic oscillations are transmitted via the high-frequency cable 28 and converted into mechanical oscillations by the actuator 22, said mechanical oscillations being transmitted to or coupled into the substrate plate 16 directly by the sound conductor 23.

A coupling point 27 is assigned to the longitudinal axis of the substrate plate 16, at which coupling point a lifting cylinder (not illustrated in any more detail) of a laser sintering machine engages, preferably in an oriented manner, in order to move the substrate plate 16 to the corresponding position within the building cylinder 15 during the production of the three-dimensional object 14. The at least one actuator 22 is preferably provided eccentrically on the substrate plate 16 in a force-fitting and/or form-fitting manner. The at least one actuator 22 is provided adjacent to the coupling point. This eccentric incoupling of the oscillations may also enable a high cleaning effect for depowdering the three-dimensional object 14.

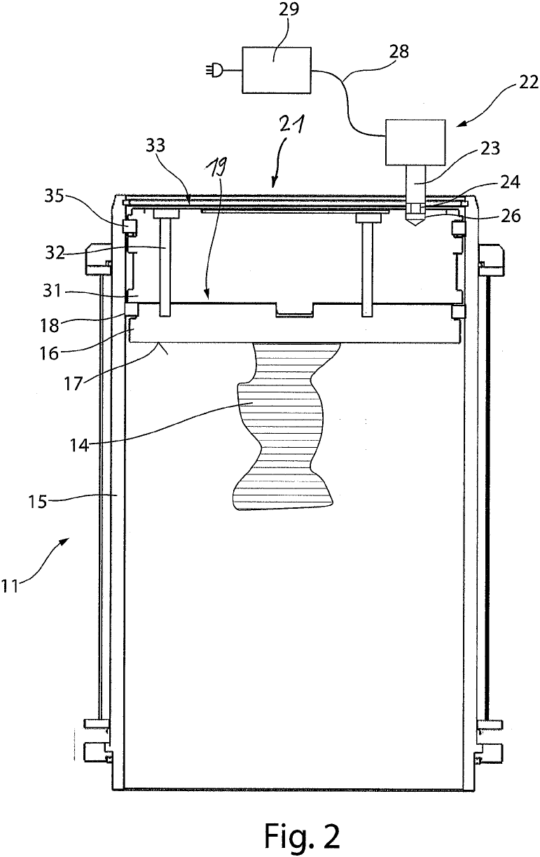

FIG. 2 illustrates an alternative embodiment of the interchangeable container 11 in relation to FIG. 1. In the case of this interchangeable container 11, provision is made for at least one transmission element 31 to be provided on an outer side 21 of the substrate plate 16. This transmission element 31 is fixedly connected to the substrate plate 16 by, preferably releasable, fastening means 32. The connection or coupling of the transmission element 31 to the substrate plate 16 is such that the transmission element 31 and the substrate plate 16 act as a common oscillation transmission element. Individual surface portions of the transmission element 31 bear directly against the outer side 21 of the substrate plate 16. The at least one actuator 22 is provided on an outer side 33 of the transmission element 31. This actuator 22 corresponds to the actuator 22 described in FIG. 1 and is arranged in an analogous manner on the transmission element 31 in accordance with one of the above-described embodiments in FIG. 1.

A further seal 35 is preferably provided on an outer periphery of the transmission element 31. Oscillation decoupling with respect to the building cylinder 15 is provided as a result of the seal 18 of the substrate plate 16 and the seal 35 on the transmission element 31.

The transmission element 31 has, on the outer side 33 thereof, a coupling point which is not illustrated in any more detail and at which a lifting cylinder, for example of a laser sintering apparatus, engages, in order to move the substrate plate 16 to the corresponding position within the building cylinder 15 during the production of the three-dimensional object 14.

In order to unpack and depowder the substrate plate 16 or the substrate plate 16 together with the transmission element 31 fastened thereto, which remain positioned in a building cylinder 15, these may be held in a secured manner with respect to the building cylinder 15. Preferably, a holding or securing device may engage with the building cylinder 15 and the substrate plate 16 and/or the transmission element 31. The holding or securing device may hold and secure the substrate plate 16 and/or the transmission element 31 in an oriented manner with respect to the lower edge of the interchangeable container 11.

The above statements apply equally to a substrate plate 16 which is provided separately from the building cylinder 15. The same applies to the transmission element 31 according to FIG. 2 which is fixedly connected to the substrate plate 16 and which is provided separately from the building cylinder 15.

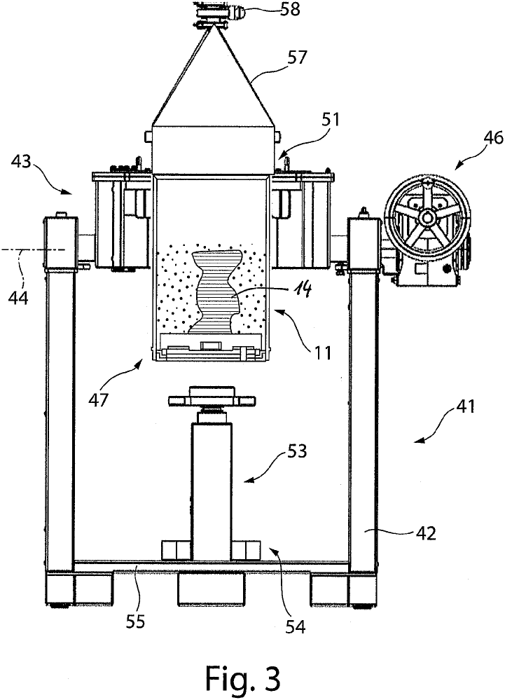

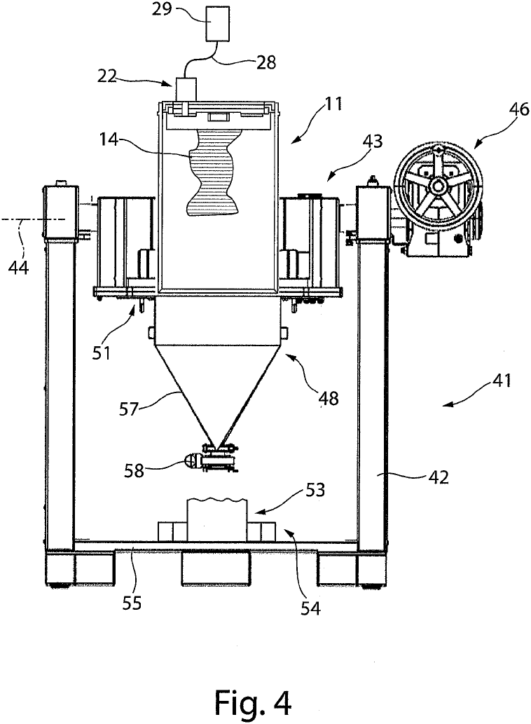

In FIG. 3, a schematic side view of an apparatus 41 for unpacking a three-dimensional object 14 produced in the interchangeable container 11 is provided. This apparatus 41 comprises a base frame 42 on which a turning apparatus 43, which can preferably be rotated about a horizontal axis 44, is provided. This turning apparatus 43 may be transferred manually by means of a handwheel 46 or by means of a drive (not illustrated in any more detail) from a first, working position 47 according to FIG. 3 to a second, emptying position 48 illustrated in FIG. 4. The turning apparatus 43 comprises a receptacle 51 into which the interchangeable container 11 can be inserted.

A lifting device 53 with a lifting cylinder is illustrated below the interchangeable container 11. This lifting device 53 is provided so as to be movable via a linear guide 54 on the base frame 42 and can be moved along a base plate 55 of the base frame 42 such that this lifting device 53 is outside a pivot range of the turning apparatus 43.

After the interchangeable container 11 filled with build material and the three-dimensional object 14 has been inserted, a cover 57 with a suction-removal opening 58 is positioned on the opening of the interchangeable container 11, a suction-removal hose being able to be fastened to said suction-removal opening in order to remove the non-solidified pulverulent build material by suction.

In order to unpack the three-dimensional object 14, the turning apparatus 43 is transferred from the first, working position 47 to the emptying position 48 according to FIG. 4. The non-solidified build material comes loose from the three-dimensional object 14 on account of gravity and accumulates in the cover 57, and is discharged via the suction-removal opening 58.

After the three-dimensional object 14 has been unpacked, the at least one actuator 22 is connected to the substrate plate 16 or to the transmission element 31 in a form-fitting and/or force-fitting manner. In particular, a mechanical connection, such as a screw connection, is provided. Then, the generator 29 is activated, by means of which ultrasonic oscillations are generated and are coupled directly into the substrate plate 16 or into the transmission element 31 by the sound conductor 23 of the actuator 22. This makes it possible for the three-dimensional object 14 to be depowdered, that is to say that, after the unpacking, still adhering non-solidified build material on the three-dimensional object 14 is removed.

After the three-dimensional object 14 has been depowdered, the actuator 22 can be removed from the substrate plate 16 or the transmission element 31 and the interchangeable container 11 can be returned to the first, working position 47. After the cover 57 has been removed, the lifting drive device 53 can be used to position the three-dimensional object 14 in a protruding manner in relation to the building cylinder 15 for removal purposes.

The above-described unpacking and depowdering of the three-dimensional object 14 applies analogously to a substrate plate inserted directly into the turning device or to a substrate plate 16 which is fixedly connected to the transmission element 31.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A substrate plate for an interchangeable container that is insertable into an apparatus for layer-by-layer application and selective solidification of a pulverulent build material for producing a three-dimensional object, the substrate plate comprising:
a surface, wherein the three-dimensional object is built on the surface, and
a connection interface situated opposite to the surface, wherein a transmission element is capable of being connected to the connection interface,
wherein at least one actuator is capable of being connected in a force-fitting and/or form-fitting manner to the substrate plate or to the transmission element fastened to the substrate plate, and wherein the at least one actuator is capable of being excited to oscillate by a generator.

2. The substrate plate according to claim 1, wherein the at least one actuator is capable of being arranged on the substrate plate or on the transmission element in a mechanically fixed manner.

3. The substrate plate according to claim 1, wherein the at least one actuator comprises a sound conductor, and the sound conductor is connected to the substrate plate or to the transmission element by screwing, clamping or bracing.

4. The substrate plate according to claim 1, wherein the generator and the at least one actuator are connected to one another via a high-frequency cable.

5. The substrate plate according to claim 1, wherein the at least one actuator is capable of being excited to ultrasonic excitation in a frequency range of 30 to 40 kHz.

6. An interchangeable container for an apparatus for layer-by-layer application and selective solidification of a pulverulent build material for producing a three-dimensional object, the interchangeable container comprising:
a building cylinder, and
a substrate plate according to claim 1, wherein the substrate plate is capable of being moved up and down in the building cylinder, and wherein the three-dimensional object is built on the substrate plate.

7. The interchangeable container according to claim 6, wherein the substrate plate is connected to a transmission element that points towards an outer side of the building cylinder, and wherein the transmission element and the substrate are capable of being moved up and down together in the building cylinder.

8. A method for unpacking a three-dimensional object produced on a substrate plate by layer-by-layer application and selective solidification of a pulverulent build material from non-solidified build material surrounding the three-dimensional object, the method comprising:
loading a turning apparatus with a substrate plate according to claim 1, wherein the substrate plate or a transmission element connected to the substrate plate is connected to at least one actuator in a force-fitting and/or form-fitting manner,
rotating the turning apparatus from an upright working position to an emptying position for unpacking the three-dimensional object by weight force of the build material, and
exciting the at least one actuator using a generator, thereby causing the substrate plate or the transmission element connected to the substrate plate to oscillate in order to depowder the three-dimensional object.

9. The method according to claim 8, wherein the substrate plate or the transmission element coupled to the substrate plate is excited to oscillate in a frequency range of 30 to 40 kHz, by the at least one actuator.

10. The method according to claim 8, further comprising, after the three-dimensional object has been depowdered, returning the substrate plate to an upright working position using the turning apparatus for removal from the turning apparatus.

11. A method for unpacking a three-dimensional object produced by layer-by-layer application and selective solidification of a pulverulent build material in an interchangeable container from non-solidified build material surrounding the three-dimensional object, the method comprising:
loading a turning apparatus with the interchangeable container, wherein the interchangeable container includes a building cylinder, a substrate plate is capable of being moved up and down in the building cylinder, the substrate plate or a transmission element connected to the substrate plate is connected to at least one actuator in a force-fitting and/or form-fitting manner,
rotating the turning apparatus from an upright working position to an emptying position for unpacking the three-dimensional object by weight force of the build material, and
exciting the at least one actuator using a generator, thereby causing the substrate plate or the transmission element connected to the substrate plate to oscillate in order to depowder the three-dimensional object.

12. The method according to claim 11, wherein the substrate plate or the transmission element coupled to the substrate plate is excited to oscillate in in a frequency range of 30 to 40 kHz by the at least one actuator.

13. The method according to claim 11, further comprising, after the three-dimensional object has been depowdered, returning the interchangeable container to an upright working position using the turning apparatus for removal of the interchangeable container from the turning apparatus.

14. An apparatus for unpacking a three-dimensional object produced by layer-by-layer application and selective solidification of a pulverulent build materialfrom non-solidified build material surrounding the three-dimensional object, the apparatus comprising:
a turning apparatus loaded with a substrate plate according to claim 1,
wherein the turning apparatus is configured to turn the substrate plate from an upright working position to an emptying position for unpacking the non-solidified build material by weight force,
at least one actuator connected to the substrate plate or a transmission element connected to the substrate plate in a force-fitting and/or form-fitting manner, and
a generator configured to actuate the at least one actuator, thereby causing the substrate plate to oscillate in order to depowder the three-dimensional object.

15. An apparatus for unpacking a three-dimensional object produced by layer-by-layer application and selective solidification of a pulverulent build material in an interchangeable container from non-solidified build material surrounding the three-dimensional object, the apparatus comprising:
a turning apparatus configured for rotating the interchangeable container from an upright working position to an emptying position for unpacking the non-solidified build material by weight force,
wherein the interchangeable container includes a building cylinder, a substrate plate and/or a transmission element connected to the substrate plate are capable of being moved up and down in the building cylinder of the interchangeable container, and
at least one actuator connected to the substrate plate or the transmission element connected to the substrate plate in a force-fitting and/or form-fitting manner, the at least one actuator capable of being actuated to oscillate by a generator in order to depowder the three-dimensional object.
